(19) United States
(12) Patent Application Publication
(10) Pub. No.: US 2024/0005536 A1
(43) Pub. Date: Jan. 4, 2024

(54) Perspective Correction of User Input Objects

(71) Applicant: Apple Inc., Cupertino, CA (US)

(72) Inventors: Maxime Meilland, San Jose, CA (US); Emmanuel Piuze-Phaneuf, Los Gatos, CA (US)

(21) Appl. No.: 18/212,480

(22) Filed: Jun. 21, 2023

Related U.S. Application Data
(60) Provisional application No. 63/356,619, filed on Jun. 29, 2022.

(51) Int. Cl. G06T 7/50; G06F 3/04815; H04N 13/279; G06V 40/10

(52) U.S. Cl. CPC G06T 7/50; G06F 3/04815; H04N 13/279; G06V 40/107; G06T 2207/30196; G06V 2201/07

(57) ABSTRACT

In one implementation, a method of determining a display location is performed by a device including one or more processors and non-transitory memory. The method includes obtaining a camera set of two-dimensional coordinates of a user input object in a physical environment. The method includes obtaining depth information of the physical environment excluding the user input object. The method includes transforming the camera set of two-dimensional coordinates into a display set of two-dimensional coordinates based on the depth information of the physical environment excluding the user input object.

### CROSS-REFERENCE TO RELATED APPLICATIONS

This application claims priority to U.S. Provisional Patent No. 63/356,619, filed on Jun. 29, 2022, which is hereby incorporated by reference in its entirety.

### TECHNICAL FIELD

The present disclosure generally relates to systems, methods, and devices for correcting a mismatch between a camera location of a user input object and a display location of the user input object.

### BACKGROUND

In various implementations, an extended reality (XR) environment is presented by a head-mounted device (HMD). Various HMDs include a scene camera that captures an image of the physical environment in which the user is present (e.g., a scene) and a display that displays the image to the user. In some instances, this image or portions thereof can be combined with one or more virtual objects to present the user with an XR experience. In other instances, the HMD can operate in a pass-through mode in which the image or portions thereof are presented to the user without the addition of virtual objects. Ideally, the image of the physical environment presented to the user is substantially similar to what the user would see if the HMD were not present. However, due to the different positions of the eyes, the display, and the camera in space, this may not occur, resulting in impaired distance perception, disorientation, and poor hand-eye coordination.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 illustrates an example scenario related to capturing an image of physical environment and displaying the captured image in accordance with some implementations.

FIG. 3 is an image of physical environment captured by an image sensor from a particular perspective.

FIG. 4 is an overhead perspective view of the physical environment of FIG. 3.

FIG. 5A illustrates a view of the physical environment of FIG. 3 as would be seen by a left eye of a user if the user were not wearing an HMD.

FIG. 5B illustrates an image of the physical environment of FIG. 3 captured by a left image sensor of the HMD.

FIG. 6A illustrates a depth plot for a central row of a depth map of the image of FIG. 5B.

FIG. 6B illustrates a static depth plot for the central row of the depth map of the image of FIG. 5B.

FIGS. 7A-7C illustrate a composited transformed image based on the image of FIG. 5B.

FIG. 8 is a flowchart representation of a method of determining a display location in accordance with some implementations.

FIG. 9 is a block diagram of an example controller in accordance with some implementations.

FIG. 10 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for determining a display location. In various implementations, the method is performed by a device including one or more processors and non-transitory memory. The method includes obtaining a camera set of two-dimensional coordinates of a user input object in a physical environment. The method includes obtaining depth information of the physical environment excluding the user input object. The method includes transforming the camera set of two-dimensional coordinates into a display set of two-dimensional coordinates based on the depth information of the physical environment excluding the user input object.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

A physical environment refers to a physical place that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As an example, the XR system may detect movement of the electronic device presenting the XR environment (e.g., a mobile phone, a tablet, a laptop, a head-mounted device, and/or the like) and, in response, adjust graphical content and an acoustic field presented by the electronic device to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light sources, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

As described above, in an HMD with a display and a scene camera, the image of the physical environment presented to the user on the display may not always reflect what the user would see if the HMD were not present due to the different positions of the eyes, the display, and the camera in space. In various circumstances, this results in poor distance perception, disorientation of the user, and poor hand-eye coordination, e.g., while interacting with the physical environment. Thus, in various implementations, images from the scene camera are transformed such that they appear to have been captured at the location of the user's eyes using a depth map representing, for each pixel of the image, the distance from the camera to the object represented by the pixel. In various implementations, images from the scene camera are partially transformed such that they appear to have been captured at a location closer to the location of the user's eyes than the location of the scene camera.

In various implementations, the depth map is altered to reduce artifacts. For example, in various implementations, the depth map is smoothed so as to avoid holes in the transformed image. In various implementations, the depth map is clamped so as to reduce larger movements of the pixels during the transform. In various implementations, the depth map is made static such that dynamic objects do not contribute to the depth map. For example, in various implementations, the depth map values at locations of a dynamic object are determined by interpolating the depth map using locations surrounding the locations of the dynamic object. In various implementations, the depth map values at locations of a dynamic object are determined based on depth map values determined at a time the dynamic object is not at the location. In various implementations, the depth map is determined using a three-dimensional model of the physical environment without dynamic objects. Using a static depth map may increase spatial artifacts, such as the objects not being displayed at their true locations. However, using a static depth map may reduce temporal artifacts, such as flickering.

When using an altered depth map (or, even, an inaccurate depth map), a user input object, such as a hand of a user, may be displayed at a different location than the hand is detected in the physical environment. Accordingly, in various implementations, when the user attempts to interact with a virtual object at a location in the physical environment, it may be preferable to use the displayed location rather than the detected location.

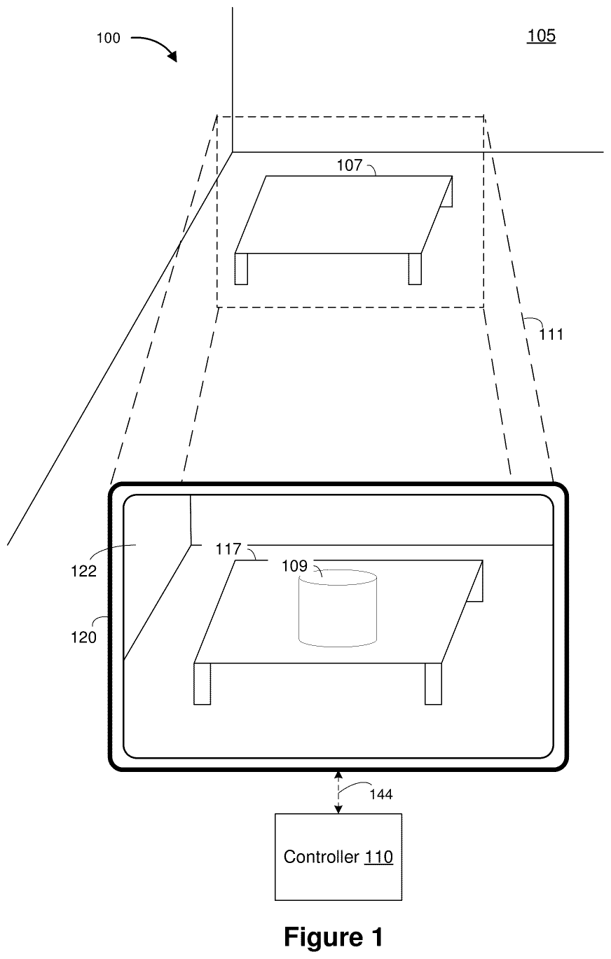

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

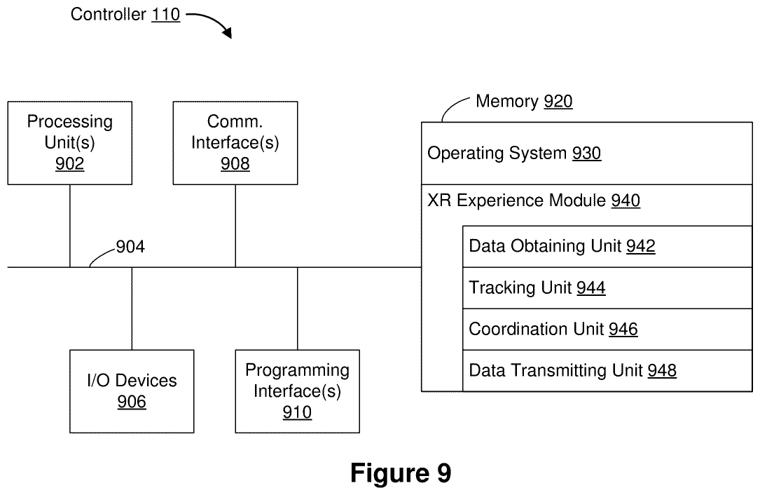

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 9. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

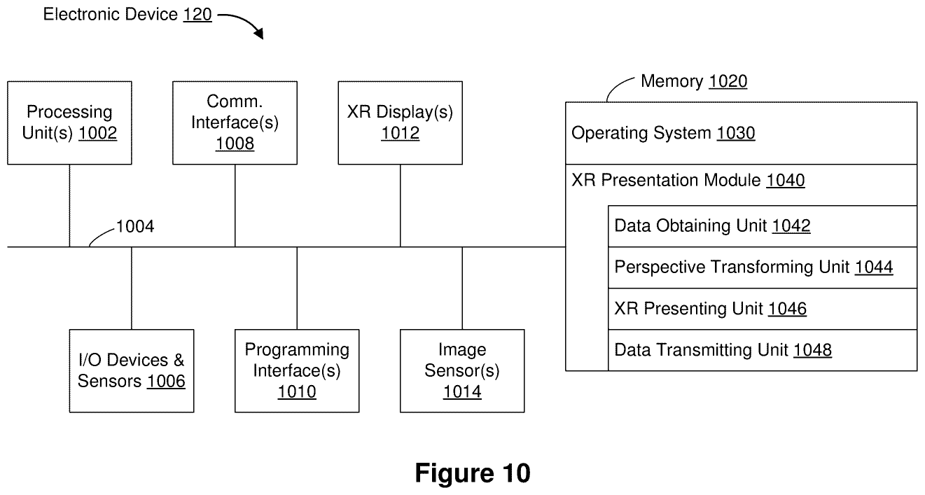

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 10.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

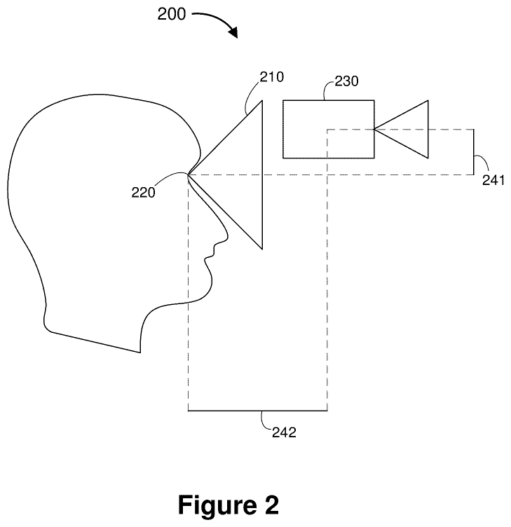

FIG. 2 illustrates an example scenario 200 related to capturing an image of an environment and displaying the captured image in accordance with some implementations. A user wears a device (e.g., the electronic device 120 of FIG. 1) including a display 210 and an image sensor 230. The image sensor 230 captures an image of a physical environment and the display 210 displays the image of the physical environment to the eyes 220 of the user. The image sensor 230 has a perspective that is offset vertically from the perspective of the user (e.g., where the eyes 220 of the user are located) by a vertical offset 241. Further, the perspective of the image sensor 230 is offset longitudinally from the perspective of the user by a longitudinal offset 242. Further, in various implementations, the perspective of the image sensor 230 is offset laterally from the perspective of the user by a lateral offset (e.g., into or out of the page in FIG. 2).

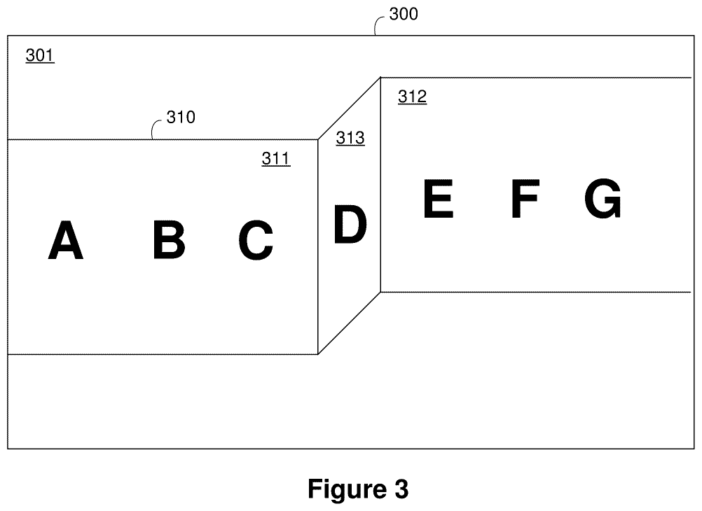

FIG. 3 is an image 300 of a physical environment 301 captured by an image sensor from a particular perspective. The physical environment 301 includes a structure 310 having a first surface 311 nearer to the image sensor, a second surface 312 further from the image sensor, and a third surface 313 connecting the first surface 311 and the second surface 312. The first surface 311 has the letters A, B, and C painted thereon, the third surface 313 has the letter D painted thereon, and the second surface 312 has the letters E, F, and G painted thereon.

From the particular perspective, the image 300 includes all of the letters painted on the structure 310. However, from other perspectives, as described below, a captured image may not include all the letters painted on the structure 310.

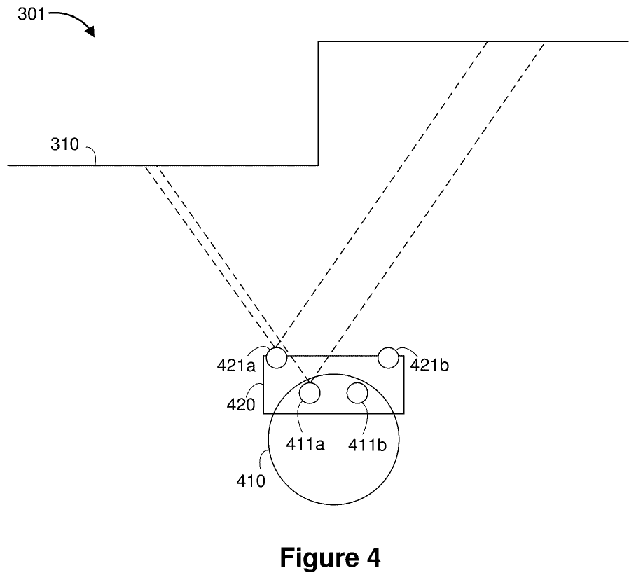

FIG. 4 is an overhead perspective view of the physical environment 301 of FIG. 3. The physical environment 301 includes the structure 310 and a user 410 wearing an HMD 420. The user 410 has a left eye 411a at a left eye location providing a left eye perspective. The user 410 has a right eye 411b at a right eye location providing a right eye perspective. The HMD 420 includes a left image sensor 421a at a left image sensor location providing a left image sensor perspective. The HMD 420 includes a right image sensor 421b at a right image sensor location providing a right image sensor perspective. Because the left eye 411a of the user 410 and the left image sensor 421a of the HMD 420 are at different locations, they each provide different perspectives of the physical environment.

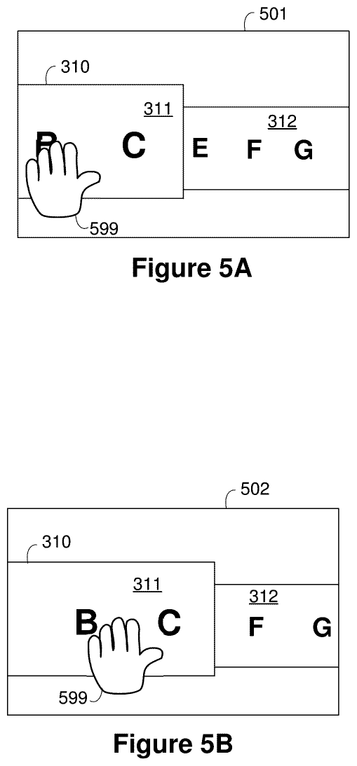

FIG. 5A illustrates a view 501 of the physical environment 301 as would be seen by the left eye 411a of the user 410 if the user 410 were not wearing the HMD 420. In the view 501, the first surface 311 and the second surface 312 are present, but the third surface 313 is not. On the first surface 311, the letters B and C can be at least partially seen, whereas the letter A is not in the field-of-view of the left eye 411a. Similarly, on the second surface 312, the letters E, F, and G can be seen. The view 501 further includes a left hand 599 of the user in front of the first surface 311 partially occluding the letter B.

FIG. 5A illustrates an image 502 of the physical environment 301 captured by the left image sensor 421a. In the image 502, like the view 501, the first surface 311 of the structure 310 and the second surface 312 of the structure 310 are present, but the third surface 313 is not. On the first surface 311, the letters B and C can be seen, whereas the letter A is not in the field-of-view of the left image sensor 421a. Similarly, on the second surface 312, the letters F and G can be seen, whereas the letter E is not in the field-of-view of the left image sensor 421a. Notably, in the image 502, as compared to the view 502, the letter E is not present on the second surface 312. Thus, the letter E is in the field-of-view of the left eye 411a, but not in the field-of-view of the left image sensor 421a. The image 502 further includes the left hand 599 of the user in front of the first surface 311 approximately midway between the letters B and C and occluding neither.

In various implementations, the HMD 420 transforms the image 502 to make it appear as though it was captured from the left eye perspective rather than the left image sensor perspective, e.g., to appear as the view 501. In various implementations, the HMD 420 transforms the image 502 based on the image 502, depth values associated with image 502, and a difference between the left image sensor perspective and the left eye perspective. In various implementations, the difference between the left image sensor perspective and the left eye perspective is determined during a calibration procedure. In various implementations, the depth value for a pixel of the image represents the distance from the left image sensor 421a to an object in the physical environment represented by the pixel. In various implementations, the depth values are used to generate a depth map including a respective depth value for each pixel of the image 502. In various implementations, for each pixel location of the transformed image, a corresponding pixel location of the image 502 is determined based on depth value associated with the pixel location.

In various implementations, the resulting transformed image includes holes, e.g., pixel locations of the transformed image for which there is no corresponding pixel location of the image 502. Such holes may be filled via interpolation or using additional images, such as another image from a different perspective (e.g., from the right image sensor 421b or from the left image sensor 421a at a different time).

In various implementations, the resulting transformed image includes ambiguities, e.g., pixel locations of the transformed image for where there are multiple corresponding pixel locations of the image 502. Such ambiguities may be disambiguated using averaging or consensus algorithms.

In various implementations, the depth map excludes dynamic objects and/or includes only static objects. In various implementations, the depth map excludes movable object and/or includes only fixed objects. In various implementations, the depth map excludes temporary objects and/or includes only permanent objects. Thus, in various implementations, the depth map excludes the left hand 599 of the user. For each pixel location representing the left hand 599 of the user in the image 502, the depth value is determined by ignoring the distance from the left image sensor 421a to the left hand 599 of the user. Rather, the depth value represents the distance from the left image sensor 421a to a static object behind the left hand 599 of the user. In various implementations, the depth value is determined by interpolating the depth values of pixels surrounding the pixel location representing the left hand 599 of the user. In various implementations, the depth value is determined based on depth values of the pixel location at a time the left hand 599 of the user is not at the pixel location. In various implementations, the depth value is determined using a three-dimensional model of the physical environment 301 excluding the left hand 599 of the user.

Using a static depth map may increase spatial artifacts, such as the left hand 599 of the user not being displayed at its true location in the physical environment 301. Thus, a user feels (using proprioception or kinesthesia) the left hand 599 of the user at a different location than the user sees the left hand 599 of the user. However, using a static depth map may reduce temporal artifacts, such as flickering.

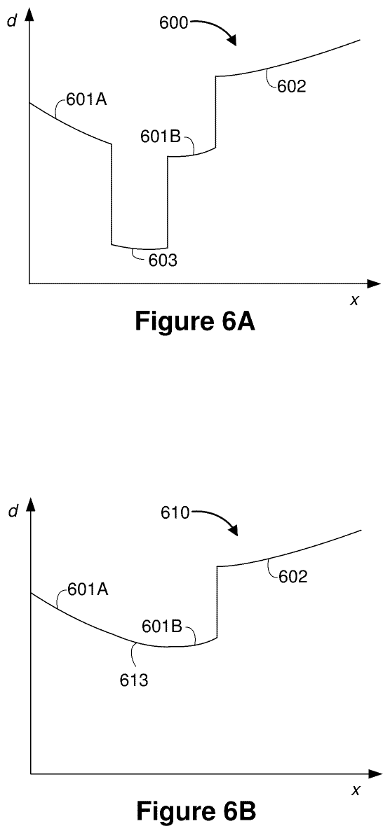

FIG. 6A illustrates a depth plot 600 for a central row of a depth map of the image 502. The depth plot 600 includes a left first portion 601A corresponding to the distance between the left image sensor 421A and various points on the first surface 311 of the structure 310 to the left of the left hand 599 of the user and a right first portion 601B corresponding to the distance between the left image sensor 421A and various points on the first surface 311 of the structure 310 to the right of the left hand 599 of the user. The depth plot 600 includes a second portion 602 corresponding to the distance between the left image sensor 421A and various points on the second surface 312 of the structure 310. The depth plot 600 includes a third portion 603 corresponding to the distance between the left image sensor 421A and various points on the left hand 599 of the user.

FIG. 6B illustrates a static depth plot 610 for a central row of a static depth map of the image 502. The static depth plot 610 includes the left first portion 601A, the right first portion 601B, and the second portion 602. However, rather than including the third portion 603, the static depth plot 610 includes a static third portion 613 corresponding to the distance between the left scene camera 421A and various points on the first surface 311 of the structure 310 behind the left hand 599 of the user. In various implementations, the static third portion 613 is generated via interpolation, earlier measurements when the left hand 599 was not present, or a three-dimensional model of the physical environment 301.

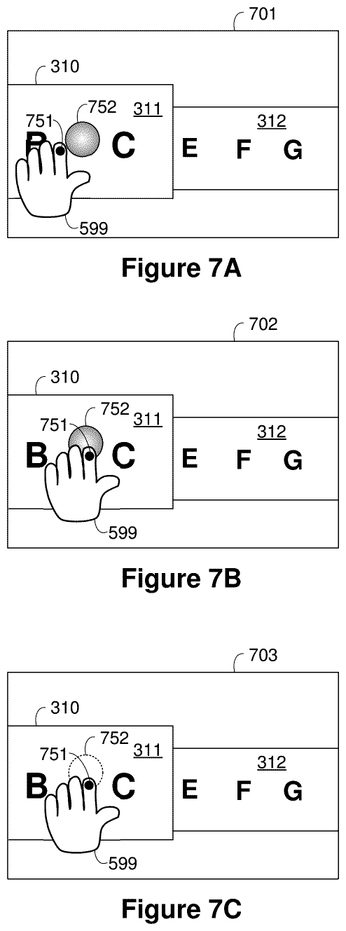

FIG. 7A illustrates a first composited transformed image 701. The first composite image 701 is based on the image 502 of the physical environment 301 captured by the left image sensor 421a and an image of virtual content including a virtual input point 751 and a virtual bubble 752. The virtual input point 751 is displayed at a location on the left hand 599 of the user (at the tip of the index finger). The virtual bubble 752 is a three-dimensional virtual object virtually located at a location in the physical environment 301 between the user 410 and the structure 310 at approximately the same depth as the left hand of the user 599.

In various implementations, the image 502 of the physical environment 301 is transformed before the transformed image is composited with the image of virtual content. In various implementations, the image 502 of the physical environment 301 is composited with the image of virtual content before the composited image is transformed.

In FIG. 7A, the image 502 of the physical environment 301 (or the composited image) is transformed using the depth plot 600 of FIG. 6A. Accordingly, as in the view 501, the left hand 599 of the user partially occludes the letter B on the first surface 311.

FIG. 7B illustrates a second composited transformed image 702. In FIG. 7B, the image 502 of the physical environment 301 (or the composited image) is transformed using the depth plot 610 of FIG. 6B. Accordingly, as in the image 502, the left hand 599 of the user is between the letters B and C on the first surface 311 and occludes neither.

In various implementations, the location in the physical environment 301 of the left hand 599 of the user is determined so as to provide a user input at the location in the physical environment 301. However, the location that the left hand 599 of the user is displayed in the second composited image 702 does not correspond to the location of the left hand 599 of the user in the physical environment 301. If the user were to provide a user input with the left hand 599 of the user at the location in the physical environment 301 of the virtual bubble 752 to interact with the virtual bubble 752, the user would not see the left hand 599 of the user at the location of the virtual bubble 752. Similarly, if the user were to provide a user input with the left hand 599 of the user at a location in the physical environment 301 where the left hand 599 of the user is displayed at the location of the virtual bubble 752, the user would fail to interact with the virtual bubble 752.

Thus, in various implementations, the location in the physical environment 301 of the left hand 599 of the user is transformed and the transformed location is used for purposes of providing user input. In various implementations, the three-dimensional physical location in the physical environment 301 is projected into a two-dimensional left camera location in the image 502 (e.g., wherein the virtual input point 751 is displayed in FIG. 7A) and projected into a two-dimensional right camera location in a corresponding image captured by the right image sensor 421b. The left camera location is transformed into a two-dimensional left display location (e.g., where the virtual input point 751 is displayed in FIG. 7B) using the depth information excluding the hand of the user. The right camera location is transformed into a two-dimensional right display location using the depth information excluding the left hand 599 of the user. The left camera location and right camera location are used to triangulate a three-dimensional input location in the physical environment 301.

FIG. 7C illustrates a third composited transformed image 703. In FIG. 7C, the image 502 of the physical environment 301 (or the composited image) is transformed using the depth plot 610 of FIG. 6B. Accordingly, as in the image 502, the left hand 599 of the user is between the letters B and C on the first surface 311 and occludes neither. Further, in response to detecting the left hand 599 of the user at the input location in the physical environment 301 which is the same location in the physical environment 301 as the virtual bubble 752, display of the virtual bubble 752 is changed, e.g., popped, in FIG. 7C.

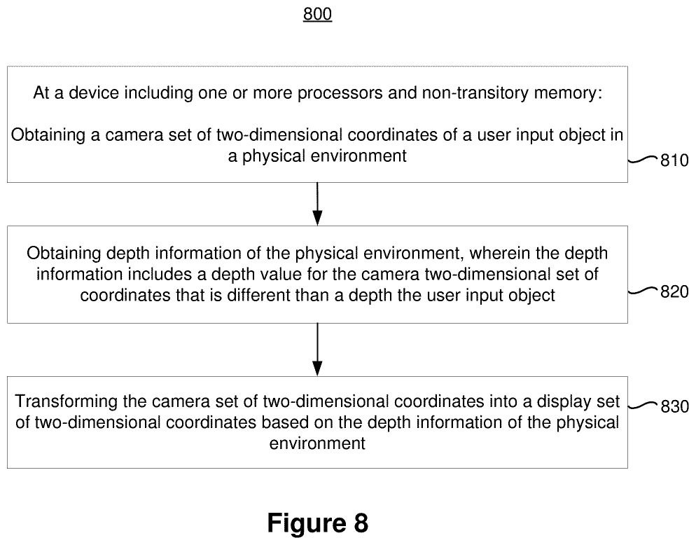

FIG. 8 is a flowchart representation of a method of determining a display location in accordance with some implementations. In various implementations, the method 800 is performed by a device with one or more processors, non-transitory memory, an image sensor, and a display (e.g., the electronic device 120 of FIG. 1). In some implementations, the method 800 is performed by processing logic, including hardware, firmware, software, or a combination thereof. In some implementations, the method 800 is performed by a processor executing instructions (e.g., code) stored in a non-transitory computer-readable medium (e.g., a memory).

The method 800 begins, in block 810, with the device obtaining a camera set of two-dimensional coordinates of a user input object in a physical environment. In various implementations, the user input object is a hand of a user. In various implementations, the two-dimensional coordinates of the hand of the user are the location of a joint of the hand of the user. Although the method 800 is primarily described for a single joint, it is to be appreciated that the method 800 can be performed for many joints of the hand. In various implementations, the user input object is a handheld device, such as a stylus. In various implementations, the set of two-dimensional coordinates of the stylus is the location of a tip of the stylus.

In various implementations, obtaining the camera set of two-dimensional coordinates of the user input object includes obtaining a physical set of three-dimensional coordinates in the physical environment of the user input object and projecting the physical set of three-dimensional coordinates to a camera image plane. In various implementations, the physical set of three-dimensional coordinates are obtained using a hand detection algorithm applied to images of the physical environment. The images may be captured by the one or more images sensors of the device or by other cameras in the physical environment. In various implementations, the physical set of three-dimensional coordinates are obtained from the user input object, e.g., from the stylus based on an inertial measurement unit (IMU) of the stylus.

In various implementations, obtaining the camera set of two-dimensional coordinates of the user input object includes detecting the user input object in an image of the physical environment.

The method 800 continues, in block 820, with the device obtaining depth information of the physical environment, wherein the depth information includes a depth value for the camera set of two-dimensional coordinates that is different than a depth to the user input object. For example, in various implementations, the depth value for the camera set of two-dimensional coordinates represents a depth to a static object behind the user input object.

In various implementations, the depth information includes a depth map for the physical environment. In various implementations, the depth map is based on an initial depth map in which the value of each pixel represents the depth to the object represented by the pixel. For example, the depth map may be an altered version of the initial depth map. In various implementations, the method 800 includes transforming an image of the physical environment based on the depth map. In various implementations, the transformation is based on a difference between the perspective of the image sensor that captured the image of the physical environment and the perspective of the user. In various implementations, the method 800 includes displaying the transformed image.

In various implementations, for each pixel location representing the user input object, the depth value of the depth map is determined ignoring the depth to the user input object. Thus, in various implementations, the depth information of the physical environment is a static depth map. Accordingly, in various implementations, the depth information excludes dynamic objects and/or includes only static objects. In various implementations, the depth information excludes moveable objects and/or includes only fixed objects. In various implementations, the depth information excludes temporary objects and/or includes only permanent objects.

In various implementations, the depth value is determined by interpolating the depth values of one or more pixels near the pixel location, but not representing the user input object. Thus, in various implementations, obtaining the depth information of the physical environment includes determining the depth value for the camera set of two-dimensional coordinates via interpolation using depth values of locations surrounding the camera set of two-dimensional coordinates.

In various implementations, the depth value is determined based on one or more depth values of the pixel location at a time the user input object was not at the pixel location. Thus, in various implementations, obtaining the depth information of the physical environment includes determining the depth value for the camera set of two-dimensional coordinates at a time the user input object was not at the camera set of two-dimensional coordinates.

In various implementations, the depth value is determined using a three-dimensional model of the physical environment. For example, the depth value can be determined using ray tracing from the camera location through the image plane at the pixel location to a static object in the three-dimensional model. Thus, in various implementations, obtaining the depth information of the physical environment includes determining a depth value for the camera set of two-dimensional coordinates based on a three-dimensional model of the physical environment.

In various implementations, the depth information of the physical environment is a smoothed depth map resulting from spatially filtering an initial depth map. In various implementations, the depth information of the physical environment is a clamped depth map in which each pixel of an initial depth map having a value below a depth threshold is replaced with the depth threshold.

The method 800 continues, in block 830, with the device transforming the camera set of two-dimensional coordinates into a display set of two-dimensional coordinates based on the depth information. In various implementations, the display set of two-dimensional coordinates is determined according to the following relation in which x_{c} and y_{c} are the camera set of two-dimensional coordinates, x_{d} and y_{d} are the display set of two-dimensional coordinates, P_{c} is a 4×4 view projection matrix of the image sensor representing the perspective of the image sensor, P_{d} is a 4×4 view projection matrix of the user representing the perspective of the user, and d is the depth map value at the camera set of two-dimensional coordinates:

$$[ \begin{matrix}{x}_{d} \\ {y}_{d}\end{matrix} ] ← {P}_{d} \cdot {P}_{c}^{- 1} \cdot [ \begin{matrix}{x}_{c} \\ {y}_{c} \\ d \\ 1\end{matrix} ] .$$

In various implementations, the method 800 further comprises determining an input set of three-dimensional coordinates in the physical environment by triangulating the display set of two-dimensional coordinates and a second display set of two-dimensional coordinates. In various implementations, the second display set of two-dimensional coordinates are obtained in a similar manner to the display set of two-dimensional coordinates for a second camera plane or second image sensor, e.g., for a second eye of the user wherein the display set of two-dimensional coordinates are determined for a first eye of the user. For example, in various implementations, the device projects the physical set of three-dimensional coordinates to a second image plane to obtain a second camera set of two-dimensional coordinates and transforms them, using depth information, to generate the second display set of two-dimensional coordinates.

In various implementations, the method 800 includes determining a user input according to the input set of three-dimensional coordinates. In various implementations, the user input is associated with the input set of three-dimensional coordinates. In various implementations, the user input includes presence of the user input object at the input set of three-dimensional coordinates. In various implementations, the user input is associated with a location on a ray passing through the input set of three-dimensional coordinates (and, in various implementations, a second input set of three-dimensional coordinates of the user input object). Thus, in various implementations, the user input includes the user input object pointing at a location from the input set of three-dimensional coordinates. In various implementations, determining the user input includes detecting a hand gesture. In various implementations, the method 800 includes changing display of virtual content in response to the user input. For example, in FIG. 7C, in response to detecting the input location of the left hand 599 of the user at the location of the virtual bubble 752, the virtual bubble 752 pops.

In various implementations, the method 800 includes displaying virtual content at the display set of two-dimensional coordinates. For example, FIG. 7B includes the virtual input point 751 displayed at the display set of two-dimensional coordinates.

FIG. 9 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 902 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 906, one or more communication interfaces 908 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 910, a memory 920, and one or more communication buses 204 for interconnecting these and various other components.

In some implementations, the one or more communication buses 904 include circuitry that interconnects and controls communications between system components. In some implementations, the one or more I/O devices 906 include at least one of a keyboard, a mouse, a touchpad, a joystick, one or more microphones, one or more speakers, one or more image sensors, one or more displays, and/or the like.

The memory 920 includes high-speed random-access memory, such as dynamic random-access memory (DRAM), static random-access memory (SRAM), double-data-rate random-access memory (DDR RAM), or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 comprises a non-transitory computer readable storage medium. In some implementations, the memory 920 or the non-transitory computer readable storage medium of the memory 920 stores the following programs, modules and data structures, or a subset thereof including an optional operating system 930 and an XR experience module 940.

The operating system 930 includes procedures for handling various basic system services and for performing hardware dependent tasks. In some implementations, the XR experience module 940 is configured to manage and coordinate one or more XR experiences for one or more users (e.g., a single XR experience for one or more users, or multiple XR experiences for respective groups of one or more users). To that end, in various implementations, the XR experience module 940 includes a data obtaining unit 942, a tracking unit 944, a coordination unit 946, and a data transmitting unit 948.

In some implementations, the data obtaining unit 942 is configured to obtain data (e.g., presentation data, interaction data, sensor data, location data, etc.) from at least the electronic device 120 of FIG. 1. To that end, in various implementations, the data obtaining unit 942 includes instructions and/or logic therefor, and heuristics and metadata therefor.

In some implementations, the tracking unit 944 is configured to map the physical environment 105 and to track the position/location of at least the electronic device 120 with respect to the physical environment 105 of FIG. 1. To that end, in various implementations, the tracking unit 944 includes instructions and/or logic therefor, and heuristics and metadata therefor.

In some implementations, the coordination unit 946 is configured to manage and coordinate the XR experience presented to the user by the electronic device 120. To that end, in various implementations, the coordination unit 946 includes instructions and/or logic therefor, and heuristics and metadata therefor.

In some implementations, the data transmitting unit 948 is configured to transmit data (e.g., presentation data, location data, etc.) to at least the electronic device 120. To that end, in various implementations, the data transmitting unit 948 includes instructions and/or logic therefor, and heuristics and metadata therefor.

Although the data obtaining unit 942, the tracking unit 944, the coordination unit 946, and the data transmitting unit 948 are shown as residing on a single device (e.g., the controller 110), it should be understood that in other implementations, any combination of the data obtaining unit 942, the tracking unit 944, the coordination unit 946, and the data transmitting unit 948 may be located in separate computing devices.

Moreover, FIG. 9 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 9 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 10 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 1010, one or more XR displays 1012, one or more optional interior- and/or exterior-facing image sensors 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 1012 are configured to provide the XR experience to the user. In some implementations, the one or more XR displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 1012 correspond to diffractive, reflective, polarized, holographic, etc. waveguide displays. For example, the electronic device 120 includes a single XR display. In another example, the electronic device includes an XR display for each eye of the user. In some implementations, the one or more XR displays 1012 are capable of presenting MR and VR content.

In some implementations, the one or more image sensors 1014 are configured to obtain image data that corresponds to at least a portion of the face of the user that includes the eyes of the user (any may be referred to as an eye-tracking camera). In some implementations, the one or more image sensors 1014 are configured to be forward-facing so as to obtain image data that corresponds to the physical environment as would be viewed by the user if the electronic device 120 was not present (and may be referred to as a scene camera). The one or more optional image sensors 1014 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 comprises a non-transitory computer readable storage medium. In some implementations, the memory 1020 or the non-transitory computer readable storage medium of the memory 1020 stores the following programs, modules and data structures, or a subset thereof including an optional operating system 1030 and an XR presentation module 1040.

The operating system 1030 includes procedures for handling various basic system services and for performing hardware dependent tasks. In some implementations, the XR presentation module 1040 is configured to present XR content to the user via the one or more XR displays 1012. To that end, in various implementations, the XR presentation module 1040 includes a data obtaining unit 1042, a perspective transforming unit 1044, an XR presenting unit 1046, and a data transmitting unit 1048.

In some implementations, the data obtaining unit 1042 is configured to obtain data (e.g., presentation data, interaction data, sensor data, location data, etc.) from at least the controller 110 of FIG. 1. To that end, in various implementations, the data obtaining unit 1042 includes instructions and/or logic therefor, and heuristics and metadata therefor.

In some implementations, the perspective transforming unit 1044 is configured to transform a camera set of two-dimensional coordinates into a display set of two-dimensional coordinates. In various implementations, the perspective transforming unit 1044 is configured to transform a physical set of three-dimensional coordinates into an input set of three-dimensional coordinates. To that end, in various implementations, the perspective transforming unit 1044 includes instructions and/or logic therefor, and heuristics and metadata therefor.

In some implementations, the XR presenting unit 1046 is configured to display the transformed image via the one or more XR displays 1012. To that end, in various implementations, the XR presenting unit 1046 includes instructions and/or logic therefor, and heuristics and metadata therefor.

In some implementations, the data transmitting unit 1048 is configured to transmit data (e.g., presentation data, location data, etc.) to at least the controller 110. In some implementations, the data transmitting unit 1048 is configured to transmit authentication credentials to the electronic device. To that end, in various implementations, the data transmitting unit 1048 includes instructions and/or logic therefor, and heuristics and metadata therefor.

Although the data obtaining unit 1042, the perspective transforming unit 1044, the XR presenting unit 1046, and the data transmitting unit 1048 are shown as residing on a single device (e.g., the electronic device 120), it should be understood that in other implementations, any combination of the data obtaining unit 1042, the perspective transforming unit 1044, the XR presenting unit 1046, and the data transmitting unit 1048 may be located in separate computing devices.

Moreover, FIG. 10 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 10 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having one or more processors and non-transitory memory;
obtaining a camera set of two-dimensional coordinates of a user input object in a physical environment;
obtaining depth information of the physical environment, wherein the depth information includes a depth value for the camera set of two-dimensional coordinates that is different than a depth to the user input object; and
transforming the camera set of two-dimensional coordinates into a display set of two-dimensional coordinates based on the depth information of the physical environment.

2. The method of claim 1, wherein the user input object includes at least a portion of a hand of a user.

3. The method of claim 1, wherein the user input object includes a handheld device.

4. The method of claim 1, wherein obtaining the camera set of two-dimensional coordinates includes obtaining a physical set of three-dimensional coordinates of the user input object and projecting the physical set of three-dimensional coordinates to a camera image plane.

5. The method of claim 1, wherein obtaining the camera set of two-dimensional coordinates includes detecting the user input object in an image of a physical environment.

6. The method of claim 1, wherein the depth information of the physical environment is a smoothed depth map.

7. The method of claim 1, wherein the depth information of the physical environment is a clamped depth map.

8. The method of claim 1, wherein the depth information of the physical environment is a static depth map.

9. The method of claim 1, wherein the depth value for the camera set of two-dimensional coordinates represents a depth to a static object behind the user input object.

10. The method of claim 1, wherein obtaining the depth information of the physical environment includes determining the depth value for the camera set of two-dimensional coordinates via interpolation using depth values of locations surrounding the camera set of two-dimensional coordinates.

11. The method of claim 1, wherein obtaining the depth information of the physical environment includes determining the depth value for the camera set of two-dimensional coordinates at a time the user input object was not at the camera set of two-dimensional coordinates.

12. The method of claim 1, wherein obtaining the depth information of the physical environment includes determining the depth value for the camera set of two-dimensional coordinates based on a three-dimensional model of the physical environment excluding the user input object.

13. The method of claim 1, further comprising determining an input set of three-dimensional coordinates of the user input object by triangulating the display set of two-dimensional coordinates and a second display set of two-dimensional coordinates.

14. The method of claim 13, further comprising determining a user input according to the input set of three-dimensional coordinates.

15. The method of claim 14, further comprising changing display of virtual content in response to the user input.

16. The method of claim 1, further comprising displaying virtual content at the display set of two-dimensional coordinates.

17. The method of claim 1, further comprising:
transforming an image of the environment based on the depth information of the physical environment; and
displaying the transformed image.

18. A device comprising:
a non-transitory memory; and
one or more processors to:
obtain a camera set of two-dimensional coordinates of a user input object in a physical environment;
obtain depth information of the physical environment;
transform the camera set of two-dimensional coordinates into a display set of two-dimensional coordinates based on the depth information of the physical environment excluding the user input object; and
determining an input set of three-dimensional coordinates of the user input object by triangulating the display set of two-dimensional coordinates and a second display set of two-dimensional coordinates.

19. The device of claim 18, wherein the one or more processors are further to determine a user input according to the input set of three-dimensional coordinates.

20. A non-transitory memory storing one or more programs, which, when executed by one or more processors of a device cause the device to:
obtain a camera set of two-dimensional coordinates of a user input object in a physical environment;
obtain depth information of the physical environment, wherein the depth information includes a depth value for the camera set of two-dimensional coordinates that is different than a depth to the user input object; and
transform the camera set of two-dimensional coordinates into a display set of two-dimensional coordinates based on the depth information of the physical environment.
